(19) United States
(12) Patent Application Publication
(10) Pub. No.: US 2007/0089842 A1
(43) Pub. Date: Apr. 26, 2007

(54) Supplemental window screen mounting

(76) Inventor: Elena Marioncu Hanni, North Tonawanda, NY (US)

Correspondence Address: Elena Marioncu Hanni, 740 Payne Ave, North Tonawanda, NY, 14120, US

(21) Appl. No.: 11/580,343

(22) Filed: Oct. 14, 2006

Related U.S. Application Data
(60) Provisional application No. 60/726,670, filed on Oct. 15, 2005.

(51) Int. Cl. E06B 3/80

(52) U.S. Cl. 160/179; 160/371

(57) ABSTRACT

To mount a decorative fabric and a screen on a frame by using the same spline material to push both the decorative material and the industry-standard screen material into the same groove in the frame.

### REFERENCE TO EARLIER PROVISIONAL PATENT DATE

This application for patent claims benefit of the USPTO provisional patent application No. 60/726,670, filing date Oct. 15, 2005, by Elena Marioncu Hanni, titled: Supplemental Window Screen Mounting Process.

### BACKGROUND OF THE INVENTION

The building-industry standard-method for mounting screens in a flame is to use a ‘spline’ to press the screen material into a groove in a frame along the peripheral edge of the screen where said ‘spline’ is usually of a long cylindrical or rope-like shape of a flexible material.

Sometimes, to improve the aesthetics or impart a message, it is desirable to add designs or decorations to a window system.

Decorative screens are sometimes used to replace the typical plain screening for this purpose. The replacement screening must be structurally similar to the original screen, limiting the design choices and prohibitively increasing the cost. Sometimes the screen itself is painted, or other materials are bonded to the screens. Sometimes a separately flamed decorated screen is added to the window system.

The design claimed in this patent, the simplest and least expensive way to decorate a screen, is to add a supplemental, decorative fabric, such as synthetic lace, to the existing screen and frame by using the same industry-standard spline to push both the supplemental and the functional screen materials into the same groove.

The decorative material no longer needs to conform to the functional screen's design restrictions such as hole size and physical strength.

This can be done at time of manufacture or as an upgrade in existing window systems.

Typically, no changes to the frame, spline material, the existing (functional) screen, or their designs are required.

### BRIEF SUMMARY OF THE INVENTION

To add a supplemental, decorative fabric, such as lace, to a screen and frame by using the same industry-standard spline to push both the decorative and the standard screen materials into the same groove in the frame.

### FIELD OF THE INVENTION

Framed screen systems where the screens are attached to the frame using a ‘spline’ to hold the screen in a groove in the frame. Examples of which are, but are not limited to, windows and doors in a building.

### BRIEF DESCRIPTION OF THE DRAWINGS

FIG. 1 shows a cut-away side view of the spline material (1), the supplemental screen material (2), and the functional screen material (3) aligned in positions to be inserted into the groove (4) in the screen's frame (5). The relative positions of the supplemental screen (2) and the functional screen (3) may be reversed.

FIG. 2 shows a front view of an example of a supplemental screen.

FIG. 3 shows a front view of an example of functional screen.

FIG. 4 shows a front view of a frame with a groove.

FIG. 5 shows a front view of the final assembly with the spline (1) and the screens (2 & 3) inserted in the groove (4) in the frame (5).

### DETAILED DESCRIPTION OF THE INVENTION

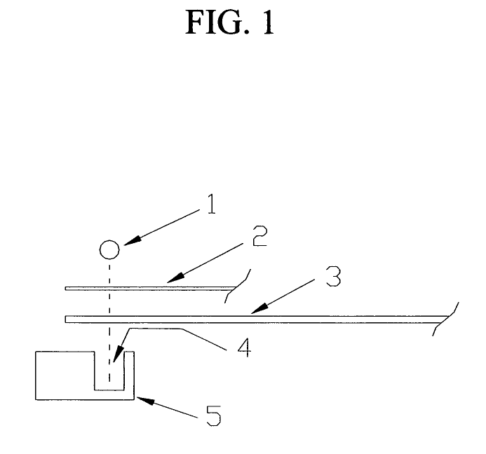

FIG. 1 shows a ‘spline’ material (1) that is usually an elongated cylinder, or ‘rope’ of an elastomeric material; a supplemental screen material (2); a functional screen material (3); and a groove (4) in a frame member (5).

FIG. 1 is a side, exploded, cutaway view of a screen frame assembly showing the components in their relative positions prior to assembly. The spline material (1), described above, is pushed into the supplemental screen material (2), which engages the functional screen material (3), and enters the groove (4) in the frame (5). The positions of the decorative screen (2) and the functional screen (3) can be exchanged so that the supplemental screen is on the other side of the functional screen.

The materials are held in place by friction.

The groove (4) in FIG. 1 is defined by its function of holding said materials and may be of a different shape.

The supplemental screen (2) may be of any material that works. The original, tested embodiment of this design uses an off-the-shelf synthetic lace fabric that was sold as a window curtain.

The functional screen (usually made of fiberglass, plastic, or aluminum), may be made of other materials. The function of the ‘functional screen’ is that function for which it was originally intended, such as keeping out bugs, ventilation and etc.

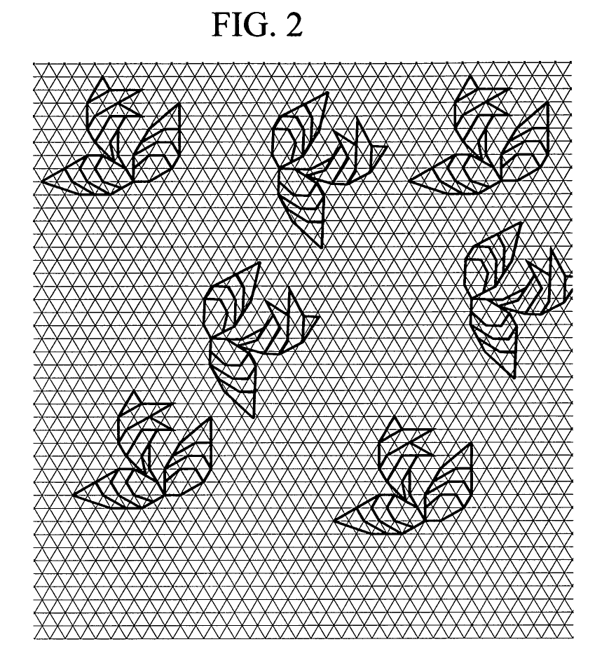

FIG. 2 shows a front view of an example of supplemental screen material. This patent is not limited to any particular design or pattern used on the supplemental screen

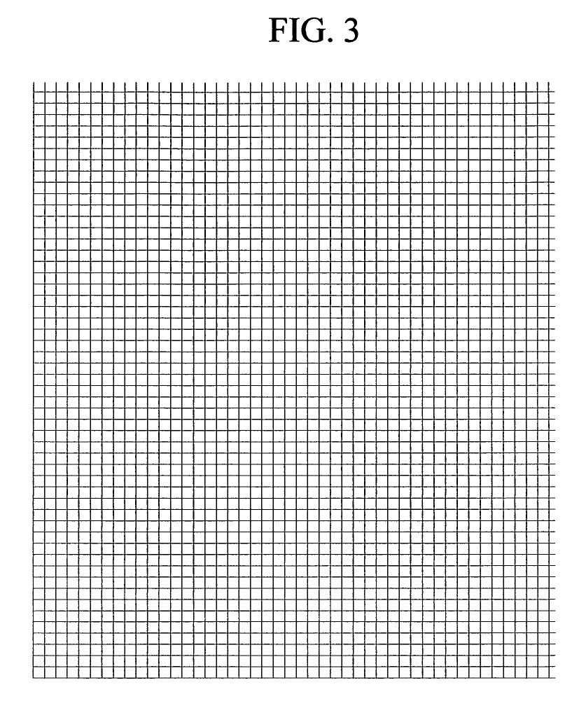

FIG. 3 shows a front view of an example of typical functional screen material.

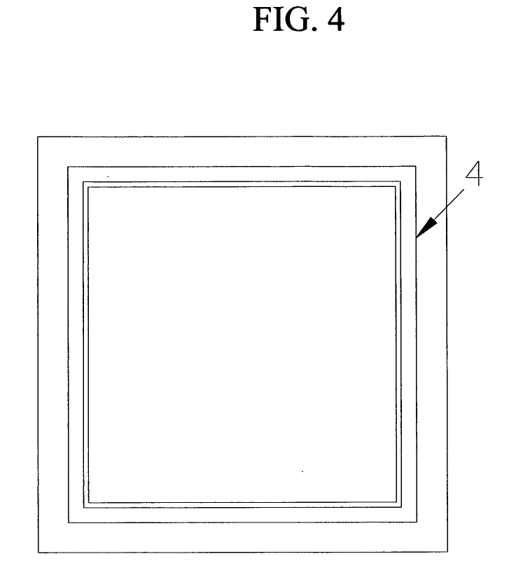

FIG. 4 shows a front view of a screen frame with a groove (4).

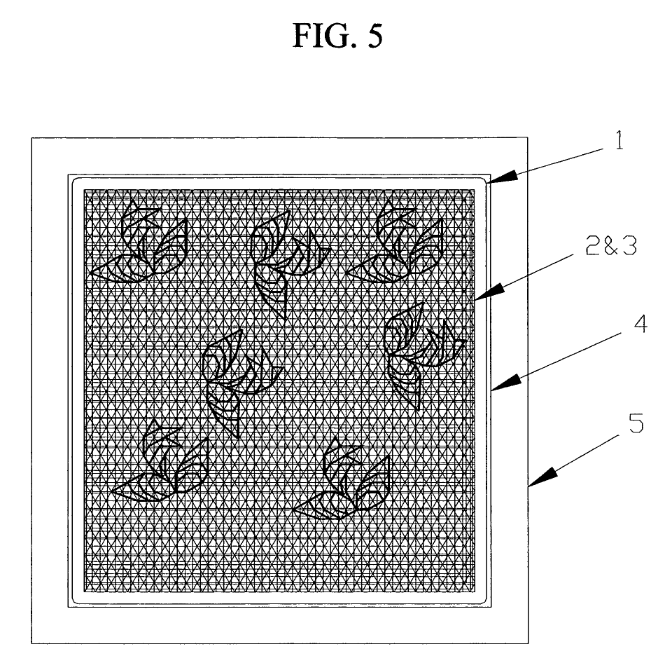

FIG. 5 shows a front view of the finished screen assembly.

I claim:

1. A supplemental fabric, screen, and frame system comprising of a frame with a peripheral groove, a supplemental fabric material, a screen material and an elastomeric spline material where the same said spline material holds both said supplemental fabric material and said screen material in the same peripheral groove in the frame.

2. The system described in claim 1 as a retro-fit to an existing screen and frame.
